(19) United States
(12) Patent Application Publication
(10) Pub. No.: US 2008/0227556 A1
(43) Pub. Date: Sep. 18, 2008

(54) Engine starter having improved helical spline structure for ensuring reliable engagement between output shaft and pinion gear

(75) Inventors: Kazuhiro Andoh, Okazaki-shi (JP); Tadahiro Kurasawa, Chita-gun (JP); Yamato Utsunomiya, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-city (JP)

(21) Appl. No.: 12/076,072

(22) Filed: Mar. 13, 2008

(30) Foreign Application Priority Data
Mar. 13, 2007 (JP) 2007-063885

(51) Int. Cl. F16D 3/44

(52) U.S. Cl. 464/158

(57) ABSTRACT

A starter includes a motor, an output shaft driven by the motor, a pinion gear provided on the output shaft, and a shifter. The output shaft has first helical splines that are formed on an outer periphery of the output shaft. The pinion gear has second helical splines that are formed on an inner periphery of the pinion gear to engage with the first helical splines. The shifter shifts the pinion gear along the output shaft through the engagement between the first and second helical splines, thereby bringing the pinion gear into mesh with a ring gear of an engine. Further, in the starter, X<Y, where X is the clearance between a bottom of the first helical splines and a top of the second helical splines, and Y is the backlash between a flank of the first helical splines and a flank of the second helical splines.

### CROSS-REFERENCE TO RELATED APPLICATION

This application is based on and claims priority from Japanese Patent Application No. 2007-63885, filed on Mar. 13, 2007, the content of which is hereby incorporated by reference in its entirety into this application.

### BACKGROUND OF THE INVENTION

1. Technical Field of the Invention

The present invention relates generally to engine starters having an output shaft and a pinion gear that engage with each other through helical splines.

More specifically, the invention relates to an engine starter which has an improved helical spline structure for ensuring a reliable engagement between an output shaft and a pinion gear of the starter.

2. Description of the Related Art

Japanese Patent Second Publication No. H7-37786 discloses a starter for starting an engine, which includes a motor, an output shaft driven by the motor, a pinion gear, and a clutch for transmitting rotation of the output shaft to the pinion gear.

More specifically, the clutch includes an outer member, an inner member, and a plurality of rollers interposed between the outer and inner members. The outer member has a barrel portion on the inner surface of which are formed first helical splines. The first helical splines engage with second helical splines that are formed on the outer surface of the output shaft. The clutch is movable along the output shaft through the engagement between the first and second helical splines. The inner member is located radially inward of the outer member and formed integrally with the pinion gear.

During the operation of starting the engine, the outer and inner members of the clutch interlock with each other through the rollers, thereby allowing the rotation of the output shaft to be transmitted to the pinion gear via the clutch. When the engine has started and the pinion gear comes to be driven by the engine, the interlock between the outer and inner members of the clutch is released, bringing the clutch into an overrun state where the inner member rotates faster than the outer member.

Further, when the outer member is not well-balanced and is thus eccentric to the inner member, an extraordinary force may act on the rollers disposed between the outer and inner members, making the overrun state unstable.

For the purpose of stabilizing the overrun state, in the above starter, a collar and an annular recess are further respectively provided on the output shaft and the inner surface of the barrel portion of the outer member. When the pinion gear is brought into mesh with a ring gear of the engine, the collar of the output shaft will be brought into the annular recess of the outer member, thereby restricting the eccentricity of the outer member to the inner member.

The inventors of the present invention have found, however, a problem with the above starter. More specifically, when a starter switch is operated twice by mistake during the engine starting operation, the pinion gear will be again brought into mesh with the ring gear immediately after being released from the first mesh between the pinion gear and the ring gear. Consequently, a great mechanical shock will occur between the pinion gear and the ring gear during establishment of the second mesh therebetween, causing an excessive force to act on both the first and second helical splines. As a result, the pinion gear will become inclined to the output shaft, and thus an excessive contact pressure will be generated between the first and second helical splines due to a local contact therebetween, causing adhesion of the first and second helical splines.

### SUMMARY OF THE INVENTION

The present invention has been made in view of the above-mentioned problem.

According to the present invention, there is provided a starter for starting an engine, which includes a motor, an output shaft driven by the motor, a pinion gear provided on the output shaft, and a shifter.

The output shaft has first helical splines that are formed on an outer periphery of the output shaft. The pinion gear has second helical splines that are formed on an inner periphery of the pinion gear to engage with the first helical splines of the output shaft. The shifter shifts the pinion gear along the output shaft through the engagement between the first and second helical splines, thereby bringing the pinion gear into mesh with a ring gear of the engine to start the engine.

Further, in the starter, there is specified the following dimensional relationship between the first helical splines of the output shaft and the second helical splines of the pinion gear:

X<Y,

where X is the clearance between a bottom of the first helical splines and a top of the second helical splines, and Y is the backlash between a flank of the first helical splines and a flank of the second helical splines.

Specifying the above dimensional relationship, it is possible to ensure a reliable engagement between the output shaft and the pinion gear. More specifically, when a great shock occurs between the output shaft and the pinion gear, the inclination of the pinion gear to the output shaft will be limited, thus securing a sufficient contact area between the first and second helical splines. As a result, adhesion of the first and second helical splines can be prevented.

In a preferred embodiment of the present invention, the output shaft further includes a cylindrical portion that is formed adjacent to the first helical splines and to be located closer to the ring gear of the engine than the first helical splines. The cylindrical portion has an outer diameter equal to a diameter of the bottom of the first helical splines. When the pinion gear is brought into mesh with the ring gear of the engine, only part of the second helical splines of the pinion gear engages with the first helical splines of the output shaft, with the remaining part of the second helical splines being supported on the cylindrical portion of the output shaft.

With the above configuration, the clearance between the outer surface of the cylindrical portion of the output shaft and the top of the second helical splines of the pinion gear is equal to the clearance X, and is accordingly smaller than the backlash Y. Therefore, in this case, it is still possible to achieve the above-described effect of limiting the inclination of the pinion gear to the output shaft, thereby ensuring a reliable engagement between the output shaft and the ring gear.

Moreover, it is also possible to make the first helical splines of the output shaft to extend to the outer surface of the cylindrical portion, so that when the pinion gear is brought into mesh with the ring gear of the engine, the entire second helical splines of the pinion gear can engage with the first helical splines. However, the first helical splines are generally formed by either form rolling or cutting, and required to have high precision. Therefore, the manufacturing cost of the starter increases with the axial length of the first helical splines. Accordingly, by configuring the output shaft to include the cylindrical portion, the axial length of the first helical splines is decreased, thereby decreasing the manufacturing cost of the starter.

In another preferred embodiment of the invention, the pinion gear has a first end and a second end that is opposite to the first end in an axial direction of the pinion gear and to be located closer to the ring gear of the engine than the first end. The pinion gear also includes a collar portion that is formed at the second end of the pinion gear to occupy an entire circumference of the pinion gear and has an inner diameter equal to a diameter of the top of the second helical splines.

With the above configuration, the collar portion of the pinion gear may serve as a sweeper or cleaner for the second helical splines. More specifically, when the pinion gear stays in its rest position, dust or mud may deposit on the outer surface of that portion of the output shaft which protrudes from the second end of the pinion gear. However, when the pinion gear is shifted toward the ring gear of the engine along the output shaft, the collar portion may serve as a sweeper to sweep off the dust or mud, thereby allowing the pinion gear to be smoothly shifted to mesh with the ring gear.

### BRIEF DESCRIPTION OF THE DRAWINGS

The present invention will be understood more fully from the detailed description given hereinafter and from the accompanying drawings of preferred embodiments of the invention, which, however, should not be taken to limit the invention to the specific embodiments but are for the purpose of explanation and understanding only.

In the accompanying drawings:

FIG. 1 is a partially cross-sectional side view showing the overall structure of a starter according to the first embodiment of the invention;

FIG. 2 is a partially cross-sectional side view showing part of the starter of FIG. 1 when a pinion gear of the starter is in its mesh position for meshing with a ring gear of an engine;

FIG. 3A is a cross-sectional view taken along the line A-A in FIG. 2;

FIG. 3B is a cross-sectional view taken along the line B-B in FIG. 2;

FIG. 4 is a partially cross-sectional side view showing part of a starter according to the second embodiment of the invention when a pinion gear of the starter is in its mesh position for meshing with a ring gear of an engine; and

FIG. 5 is a cross-sectional view taken along the line C-C in FIG. 4.

### DESCRIPTION OF PREFERRED EMBODIMENTS

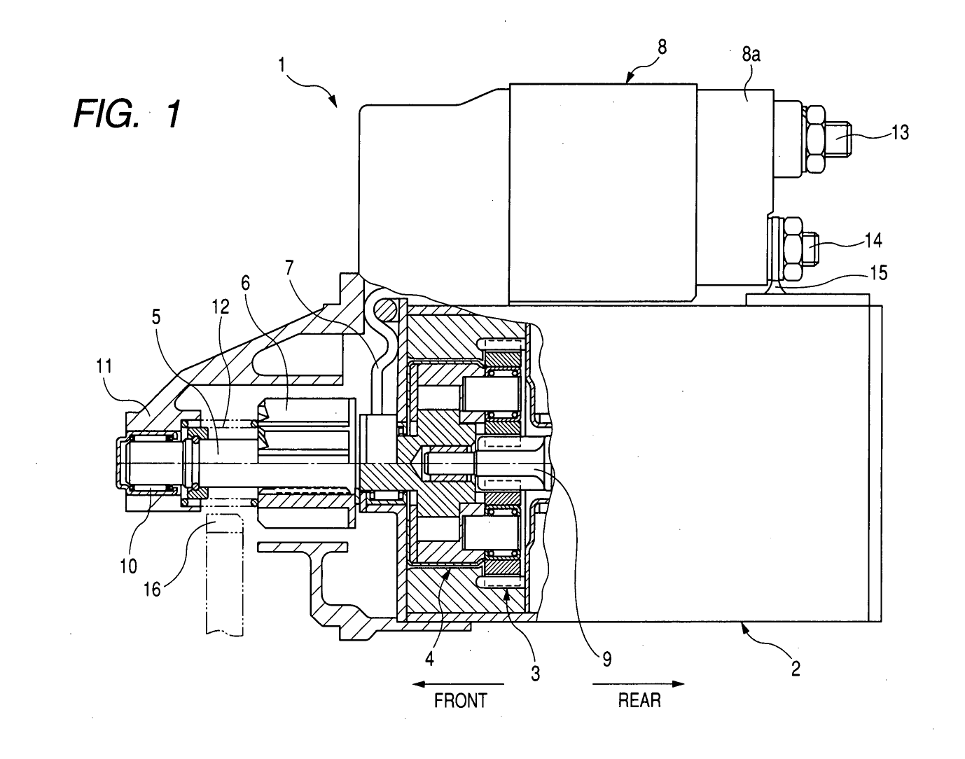

Preferred embodiments of the present invention will be described hereinafter with reference to FIGS. 1-5.

It should be noted that, for the sake of clarity and understanding, identical components having identical functions in different embodiments of the invention have been marked, where possible, with the same reference numerals in each of the figures.

### First Embodiment

FIG. 1 shows the overall structure of a starter 1 according to the first embodiment of the invention, which is designed to start an internal combustion engine (not shown) of a motor vehicle.

As shown in FIG. 1, the starter 1 includes a motor 2 that generates torque, a speed reduction gear 3 for reducing the rotational speed of the motor 2, a clutch 4, an output shaft 5 that is linked to the speed reduction gear 3 via the clutch 4, a pinion gear 6 carried on the output shaft 5, a shift lever 7, and a solenoid or electromagnetic switch 8 that operates supply of electric power to the motor 2 and causes the shift lever 7 to shift the pinion gear 6 in the axial direction.

The motor 2 receives, when main contacts (not shown) of a motor circuit are closed by the solenoid switch 8, electric power from a battery (not shown), thereby outputting torque through an armature shaft 9 of the motor 2.

The speed reduction gear 3 is of a well-known epicyclic type. The speed reduction gear 3 is arranged on a front end portion of the armature shaft 9, so that it is concentric with the armature shaft 9.

The clutch 4 is a one-way clutch which allows torque transmission from the motor 2 to the engine while inhibiting any torque transmission from the engine to the motor 2. More specifically, during the engine starting operation, the clutch 4 transmits the torque which is generated by the motor 2 and amplified by the speed reduction gear 3 to the output shaft 5. When the engine has started and the output shaft 5 comes to be driven by the engine, the clutch 4 inhibits the torque which is generated by the engine and transmitted to the output shaft 5 from further being transmitted to the armature shaft 9 of the motor 2 via the speed reduction gear 3.

The output shaft 5 is coaxially disposed with the armature shaft 9. The output shaft 5 has a front end portion that is rotatably supported by a housing 1 1 via a bearing 10 and a rear end portion that is connected to the speed reduction gear 3 via the clutch 4.

The pinion gear 6 is provided on the output shaft 5 so as to be movable along the output shaft 5 through a helical spline-engagement between the output shaft 5 and the pinion gear 6. When the starter 1 is stopped, the pinion gear 6 is urged by a pinion spring 12 provided between the housing 11 and the pinion gear 6 to stay in its rest position as shown FIG. 1.

The solenoid switch 8 includes a solenoid (not shown) and a plunger (not shown). The solenoid is configured to be energized upon turning on a starter switch (not shown). The plunger is configured to move axially (i.e., forward and backward) within the solenoid. When energized, the solenoid creates a magnetic attraction which attracts the plunger to move backward against the force of a return spring (not shown), thereby causing the main contacts of the motor circuit to be closed. Further, when the solenoid is deenergized, the magnetic attraction for the plunger disappears; thus, the plunger is moved forward by the force of the return spring to return to its initial position, thereby opening the main contacts of the motor circuit.

In addition, the main contacts of the motor circuit are constituted of a pair of fixed contacts (not shown) and a movable contact (not shown). The fixed contacts are connected to the motor circuit via terminals 13 and 14, respectively. The movable contact is configured to move along with the plunger. When the movable contact is moved forward to connect the fixed contacts, the main contacts of the motor circuit are closed. On the contrary, when the movable contact is returned backward to disconnect the fixed contacts, the main contacts of the motor circuit are opened.

Both of the terminals 13 and 14 are fixed to a resin cover 8a of the solenoid switch 8. The terminal 13 is to be connected to a plus (+) terminal of the battery via a battery cable (not shown). The terminal 14 is connected to a lead 15 drawn from the motor 2.

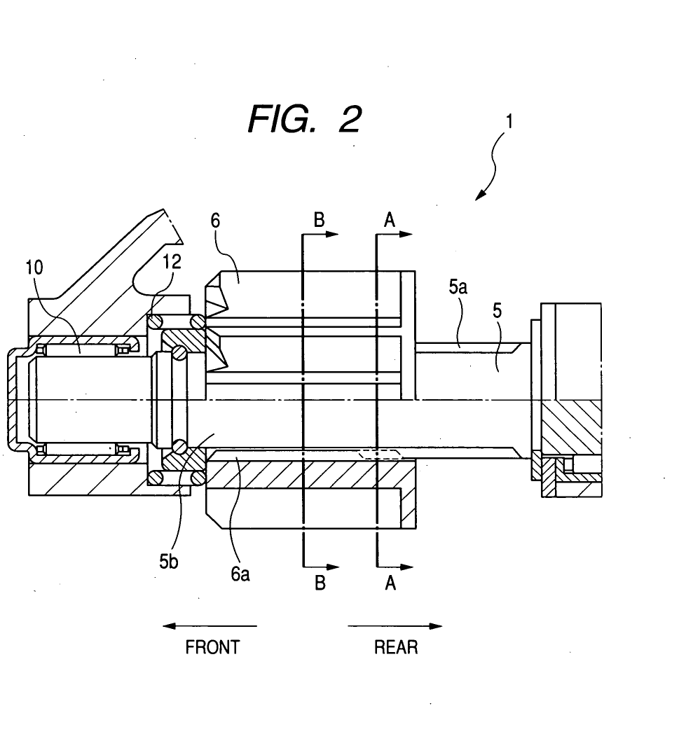

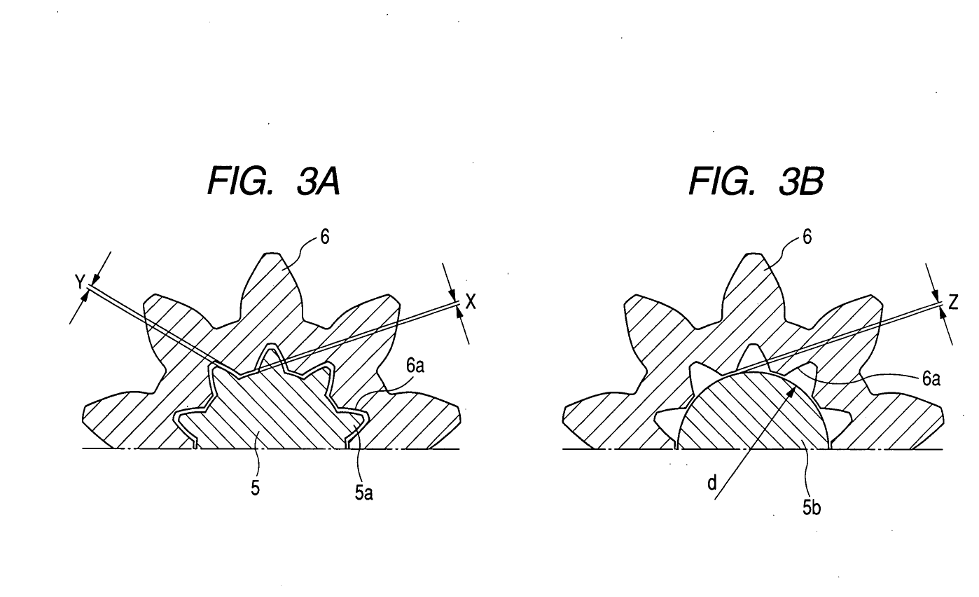

Referring now to FIGS. 2, 3A and 3B, the helical spline-engagement between the output shaft 5 and the pinion gear 6 will be described.

The output shaft 5 has first helical splines 5a that are formed on the outer surface of that portion of the output shaft 5 on which the pinion gear 6 rests when the starter 1 is stopped. The output shaft 5 also has, on the front side of the first helical splines 5a, a cylindrical portion 5b on which no helical spline is formed. The cylindrical portion 5b has an outer diameter d which is equal to a bottom diameter of the first helical splines 5a.

On the other hand, the pinion gear 6 has second helical splines 6a that are formed on the inner surface of the pinion gear 6 to engage with the first helical splines 5a of the output shaft 5.

In the present embodiment, as shown in FIG. 3A, the first and second helical splines 5a and 6a have the following dimensional relationship:

X<Y,

where X is the clearance between a bottom of the first helical splines 5a and a top of the second helical splines 6a, and Y is the backlash between flanks (or side surfaces) of the first and second helical splines 5a and 6a.

Further, in the present embodiment, when the pinion gear 6 stays in its mesh position as shown in FIG. 2, only part of the second helical splines 6a of the pinion gear 6 engages with the first helical splines 5a of the output shaft 5, with the remaining part of the second helical splines 6a being supported on the cylindrical portion 5b of the output shaft 5. In addition, in the mesh position, the pinion gear 6 is to mesh with a ring gear 16 of the engine as shown in FIG. 1.

After having described the overall structure of the starter 1, the operation thereof will be described.

When the starter switch is turned on, the solenoid of the solenoid switch 8 is energized to create the magnetic attraction, which attracts the plunger to move backward against the force of the return spring. The backward movement of the plunger causes the shift lever 7 to pivot clockwise, thereby shifting the pinion gear 6 forward along the output shaft 5 through the engagement between the first and second helical splines 5a and 6a. When the front end face of the pinion gear 6 makes contact with the rear end face of the ring gear 16, the pinion gear 6 stops against the force of the pinion spring 12.

Then, the plunger further moves backward, causing the main contacts of the motor circuit to be closed. As a consequence, electric power is supplied from the battery to the motor 2, enabling the motor 2 to generate torque. The generated torque is then transmitted, via the speed reduction gear 3 and the clutch 4, to the output shaft 5, causing the output shaft 5 to rotate together with the pinion gear 6. When the pinion gear 6 rotates to a position in which it can mesh with the ring gear 16, the pinion gear 6 is further shifted forward by the shift lever 7 to mesh with the ring gear 16. Consequently, the torque generated by the motor 2 is transmitted from the pinion gear 6 to the ring gear 16, thereby starting the engine.

After the engine has started, the starter switch is turned off, causing the solenoid of the solenoid switch 8 to be deenergized. Consequently, the magnetic attraction for the plunger disappears; thus, the plunger is moved backward by the force of the return spring to its initial position, causing the main contacts of the motor circuit to be opened. As a result, the electric power supply from the battery to the motor 2 is interrupted, causing the motor 2 to stop. At the same time, the backward movement of the plunger also causes the shift lever 7 to pivot counterclockwise; then, the pinion gear 6 is returned by the force of the pinion spring 12 to its rest position as shown in FIG. 1. As a result, the pinion gear 6 is brought out of mesh with the ring gear 16.

The above-described starter 1 according to the present embodiment has the following advantages.

In the starter 1, as described above, the clearance X between the bottom of the first helical splines 5a of the output shaft 5 and the top of the second helical splines 6a of the pinion gear 6 is made smaller than the backlash Y between the flanks of the first and second helical splines 5a and 6a.

Further, in the starter 1, the cylindrical portion 5b of the output shaft 5, which is on the front side of and adjoins to the first helical splines Sa, has the outer diameter d equal to the bottom diameter of the first helical splines 5a. Moreover, when the pinion gear 6 is shifted to its mesh position for meshing with the ring gear 16 of the engine, only part of the second helical splines 6a of the pinion gear 6 engages with the first helical splines 5a of the output shaft 5, with the remaining part of the second helical splines 6a being supported on the cylindrical portion 5b of the output shaft 5.

With the above structure, the clearance Z between the top of the second helical splines 6a of the pinion gear 6 and the outer surface of the cylindrical portion 5b of the output shaft 5, as shown in FIG. 3B, is equal to the clearance X between the top of the second helical splines 6a and the bottom of the first helical splines 5a of the output shaft 5. Therefore, the clearance Z is accordingly smaller than the backlash Y. Consequently, when a great shock occurs between the output shaft 5 and the pinion gear 6, the inclination of the pinion gear 6 to the output shaft 5 will be limited, thus securing a sufficient contact area between the first and second helical splines 5a and 6a. As a result, adhesion of the first and second helical splines 5a and 6a can be prevented.

Moreover, it is also possible to make the first helical splines 5a of the output shaft 5 to extend to the outer surface of the cylindrical portion 5b, so that when the pinion gear 6 is brought into mesh with the ring gear 16, the entire second helical splines 6a of the pinion gear 6 can engage with the first helical splines 5a. In this case, it is also possible to achieve the above-described effect of limiting the inclination of the pinion gear 6 with respect to the output shaft 5. However, the first helical splines 5a are generally formed by either form rolling or cutting, and required to have high precision. Therefore, the manufacturing cost of the starter 1 increases with the axial length of the first helical splines 5a. Accordingly, by configuring the output shaft 5 to include the cylindrical portion 5b, the axial length of the first helical splines 5a is decreased, thereby decreasing the manufacturing cost of the starter 1.

### Second Embodiment

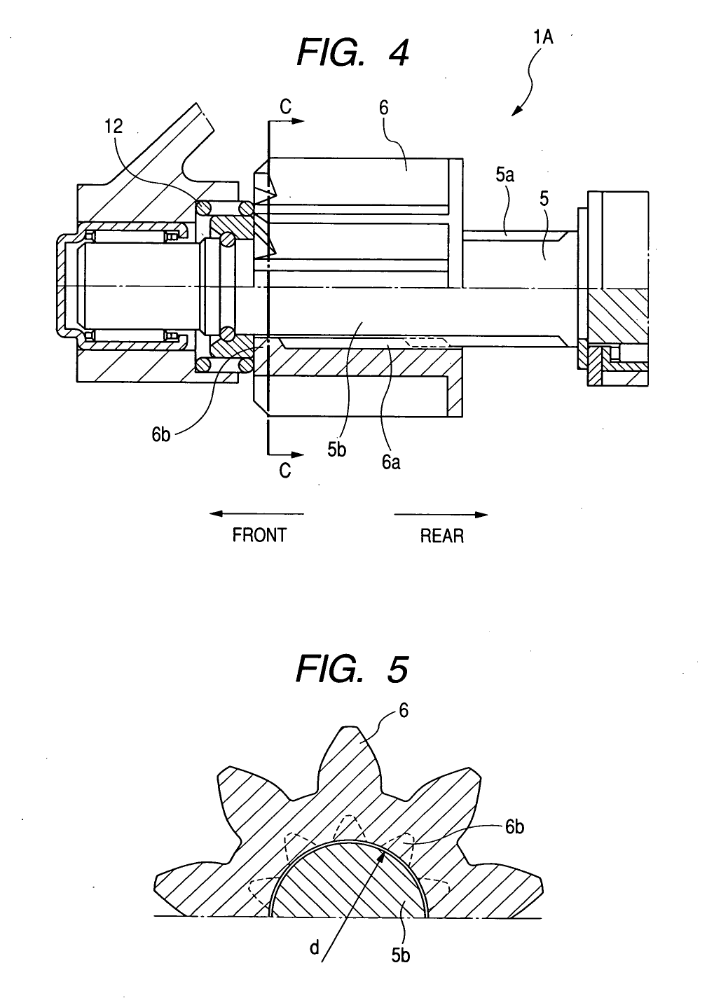

FIG. 4 shows part of a starter 1A according to the second embodiment of the present invention. The starter 1A has almost the same structure as the starter 1 according to previous embodiment. Accordingly, only the difference between the starters 1 and 1A will be described hereinafter.

In the start 1 of the previous embodiment, as shown in FIG. 2, the second helical splines 6a are so formed as to occupy the entire axial length of the pinion gear. In other words, the axial length of the second helical splines 6a is equal to the axial length of the pinion gear 6.

In comparison, in the starter 1A of the present embodiment, the pinion gear 6 further includes, as shown in FIG. 4, a collar portion 6b that is formed at the front end of the pinion gear 6. Accordingly, in the present embodiment, the axial length of the pinion gear 6 is constituted of the axial length of the second helical splines 6a and the axial length of the collar portion 6b.

Further, as shown in FIG. 5, the collar portion 6b is so formed as to occupy the entire circumference of the pinion gear 6, and has an inner diameter equal to a top diameter of the second helical splines 6a. Therefore, the clearance between the outer surface of the cylindrical portion 5b of the output shaft 5 and the inner surface of the collar portion 6b of the pinion gear 6 is equal to the clearance X between the bottom of the first helical splines 5a and the top of the second helical splines 6a.

With the above configuration, the collar portion 6b of the pinion gear 6 may serve as a sweeper or cleaner for the second helical splines 6a.

More specifically, when the pinion gear 6 stays in its rest position, dust or mud may deposit on the outer surface of the cylindrical portion 5b which protrudes forward from the pinion gear 6. Therefore, in the previous embodiment, when the pinion gear 6 is shifted forward along the output shaft 5, the dust or mud may enter the small space between the first and second helical splines 5a and 6a, making it difficult for the pinion gear 6 to be smoothly shifted to the mesh position. In comparison, in the present embodiment, when the pinion gear 6 is shifted forward along the output shaft 5, the collar portion 6b may serve as a sweeper to sweep off the dust or mud having deposited on the outer surface of the cylindrical portion 5b, thereby allowing the pinion gear 6 to be smoothly shifted to the mesh position.

While the above particular embodiments of the present invention have been shown and described, it will be understood by those skilled in the art that various modifications, changes, and improvements may be made without departing from the spirit of the invention.

Such modifications, changes, and improvements are possible within the scope of the appended claims.

What is claimed is:

1. A starter for starting an engine, the starter comprising:
a motor;
an output shaft driven by the motor, the output shaft having first helical splines that are formed on an outer periphery of the output shaft;
a pinion gear provided on the output shaft, the pinion gear having second helical splines that are formed on an inner periphery of the pinion gear to engage with the first helical splines of the output shaft; and
a shifter that shifts the pinion gear along the output shaft through the engagement between the first and second helical splines, thereby bringing the pinion gear into mesh with a ring gear of the engine to start the engine,
wherein
X<Y, where X is a clearance between a bottom of the first helical splines and a top of the second helical splines, and Y is a backlash between a flank of the first helical splines and a flank of the second helical splines.

2. The starter as set forth in claim 1, wherein the output shaft further includes a cylindrical portion that is formed adjacent to the first helical splines and to be located closer to the ring gear of the engine than the first helical splines,
the cylindrical portion has an outer diameter equal to a diameter of the bottom of the first helical splines, and
when the pinion gear is brought into mesh with the ring gear of the engine, only part of the second helical splines of the pinion gear engages with the first helical splines of the output shaft, with the remaining part of the second helical splines being supported on the cylindrical portion of the output shaft.

3. The starter as set forth in claim 1, wherein the pinion gear has a first end and a second end that is opposite to the first end in an axial direction of the pinion gear and to be located closer to the ring gear of the engine than the first end, and
the pinion gear also includes a collar portion that is formed at the second end of the pinion gear to occupy an entire circumference of the pinion gear and has an inner diameter equal to a diameter of the top of the second helical splines.
